(19) United States
(12) Patent Application Publication
(10) Pub. No.: US 2009/0015573 A1
(43) Pub. Date: Jan. 15, 2009

(54) Plasma display apparatus and semiconductor device

(75) Inventors: Takuo Nagase, Hitachi (JP); Mutsuhiro Mori, Mito (JP); Junichi Sakano, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/216,735

(22) Filed: Jul. 10, 2008

(30) Foreign Application Priority Data
Jul. 12, 2007 (JP) 2007-183533

(51) Int. Cl. G06F 3/038; G09G 3/28

(52) U.S. Cl. 345/204; 345/60

(57) ABSTRACT

A plasma display apparatus having a plurality of display cells for prolonging the luminous brightness lifetime in the single-sided drive mode has a first sustaining electrode, a second sustaining electrode connected to reference potential and cooperating with the first sustaining electrode to perform sustain discharge through a discharge space of a display cell, and an address electrode, an electrical capacitance set up between the second sustaining electrode and the discharge space is larger than that set up between the first sustaining electrode and the discharge space.

### BACKGROUND OF THE INVENTION

The present invention relates to an AC-type plasma display apparatus and a semiconductor device used therefor.

The AC-type plasma display apparatus (hereinafter simply referred to as a plasma display apparatus) can be increased in screen size more easily than the cathode-ray tube television and the like and can also be reduced in thickness and therefore, it has fast become widespread in recent years. But on the other hand, because of the wide screen, power consumption of this type of apparatus is large and reduction of power consumption has been demanded.

Structurally, a display panel of the plasma display apparatus is sandwiched between a front glass 1 and a rear glass 2 as shown in FIG. 12 or 13. On the back of the front glass 1, the display panel of plasma display apparatus has a dielectric layer 6xy on which X electrode 5x and Y electrode 5y representing sustaining electrodes are arranged alternately.

A cavity on the back of the dielectric layer 6xy is partitioned by ribs 3 to form discharge spaces 4. A surface of the rib 3 exposing to the discharge space is laid with a fluorescent layer 7 and a gas such as xenon (Xe) is filled in the discharge space 4.

Address electrodes 5a are formed on the rear glass 2. A dielectric layer 6a intervenes between the address electrode 5a and the discharge space 4.

The X electrode 5x and Y electrode 5y representing sustaining electrodes are alternately arranged substantially in parallel and the address electrodes 5a cross the X electrodes 5x and Y electrodes 5y orthogonally thereto, forming a two-dimensional matrix.

In the display panel, as electrically conceptually illustrated in FIG. 14, the X electrode 5x and Y electrode 5y are vis-à-vis the gas filled in the discharge space 4 through the medium of the dielectric layer 6xy, thus setting up capacitors Cx and Cy, respectively. Similarly, the address electrode 5a opposes the gas filled in the discharge space 4 through the medium of the dielectric layer 6a to form a capacitor Ca.

In other words, the display panel of plasma display apparatus can schematically estimated as being equivalent to a circuit including the capacitors Cx, Cy and Ca corresponding to the individual electrodes of X electrode 5x, Y electrode 5y and address electrode 5a and switches Sx, Sy and Sa provided in correspondence with the individual electrodes.

There are a reset period for resetting electric charges accumulated in each discharge space 4, an address period for selecting a light-emission (luminescence) position on the panel and a sustain period for causing the panel to emit light and controlling the luminous brightness. Then, drive control of the display panel is divided in sequence of the periods as above. In the address period, voltage is applied between the address electrode 5a and the Y electrode 5y to cause a discharge so that an electric charge (wall electric charge) may be applied to the wall surface of discharge space 4. In this manner, a cell (discharge space 4) scheduled for luminescence during the next sustain period is selected.

During the sustain period, voltages are supplied to the Y electrode 5y and X electrode 5x, so that a difference voltage Vwxy (>0) can be applied to the discharge space 4. Then, as the difference voltage grows in excess of a discharge voltage, a plasma status is set up inside the cell, entailing light emission or luminescence.

The thus established plasma status is equivalent to an electrical status in which the switches Sx, Sy and Sa shown in FIG. 14 are turned on. In this condition, the discharge capacitors Cx, Cy and Ca start discharging. Then, with the discharging completed later, emission or luminescence stops. Therefore, in order to sustain the emission, voltages are applied to the X electrode 5x and Y electrode 5y alternately during sustain period (this method will hereinafter be called double-sided drive). Schematically, when a resultant capacitance of Cx and Cy is now written by Cp, a circuit for driving in this mode includes circuit sections adapted to drive both the X electrode 5x and the Y electrode 5y, respectively, as exemplified in FIG. 15, needing a great number of electrical parts and incurring high costs. Further, currents developing during the light emission flow through switch elements of the drive circuit sections adapted to drive the X electrode 5x and Y electrode 5y, resulting in a large loss in the drive circuit.

To fulfill the task of reducing the loss and the number of parts in the drive circuit, a method called single-sided drive has been contrived as described in US2006/0007063A1, according to which for light emission, either one of the sustaining electrodes (for example, X electrode 5x) is fixed to ground, for instance, to provide Vx=0 as shown in FIG. 16 and potential of the other sustain electrode (for example, Y electrode 5y) is changed as shown at Y in FIG. 17, thereby ensuring that during the sustain period, the light emission can be maintained by alternately applying positive and negative voltages to the Y electrode 5y.

### SUMMARY OF THE INVENTION

The status inside a luminous cell driven when one of the sustaining electrodes is fixed to ground as above will now be described.

An internal status of a cell during light emission under the condition of Vx>Vy or Vy>Vx is illustrated in the form of an equivalent circuit as shown in FIG. 18 or 19. During the emission, the switches Sx, Sy and Sa are turned on and electric charges in the discharge capacitors Cx, Cy and Ca migrate to establish a balancing status determined by external voltages Vx, Vy and Va. Voltage Vd in the balancing status can be calculated as follows:

Vd=(Cx·Vx+Cx·Vy+Ca·Va)/(Cx+Cy+Ca).

Assuming that Cx=Cy=Ca stands approximately on the basis of the conventional structure, the discharge space potential Vd in the balancing status during the double-sided drive can be calculated as Vd=57V for Vx>Vy. Because of Va=0V, voltage Vwa applied to the discharge capacitor Ca on the address electrode side (hereinafter referred to as address electrode wall voltage) is 57V. For Vx<Vy, Vd=57V and Vwa=57V are held similarly. During the period for sustaining the light emission in the panel, alternate shift takes place between the status for Vx>Vy and the status for Vx<Vy. But in any case, equality of Vwa is held substantially to make the amount of electric charges on the surface of illuminants or fluorescent materials unchanged, allowing the light emission discharge to have less influence upon the illuminants.

On the other hand, in the balancing status in the single-sided drive mode where either one of the sustaining electrodes is fixed to ground, for instance, and positive and negative voltages are applied alternately to the other sustaining electrode to thereby maintain light emission, the discharge space potential Vd is calculated to provide internal states in the cell during luminescence for Vx>Vy and Vy>Vx as shown in FIGS. 20 and 21, respectively, demonstrating that the address electrode wall voltage Vwa changes from 10V to −57V. Conceivably, this change causes the amount of electric charges on the surface of fluorescent materials to change and damage of the fluorescent materials by the light emission discharge becomes more serious than that in the double-sided drive mode, thus shortening the luminous lifetime of the panel.

The present invention has been made in the light of the circumstances as above and it is an object of this invention to provide a plasma display apparatus capable of prolonging the luminous brightness lifetime of the panel even in the single-sided drive mode.

According to an embodiment of the present invention, a plasma display apparatus having a plurality of display cells, comprises a first sustaining electrode, a second sustaining electrode connected to reference potential to cooperate with the first sustaining electrode to perform sustain discharge through a discharge space of the display cell and an address electrode, wherein an electrical capacitance between the second sustaining electrode and the discharge space is made to be larger than an electrical capacitance between the first sustaining electrode and the discharge space.

With the above construction, the change of address electrode wall voltage can be suppressed.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram illustrating an example of configuration of a plasma display apparatus according to an embodiment of the present invention.

FIG. 2 is a perspective view illustrating an example of structure of a display panel of the plasma display apparatus in the embodiment of the invention.

FIG. 3 is a sectional view taken on line III-III in the FIG. 2 display panel.

FIG. 4 is an electrically conceptual diagram equivalent to the FIG. 2 display panel.

FIG. 5 is a schematic circuit diagram showing an example of a drive circuit of the FIG. 2 display panel.

FIG. 6 is a graphical representation useful to explain an example of an experiment of changing the address electrode wall voltage in relation to a ratio between discharge capacitances of individual sustaining electrodes.

FIG. 7 is a sectional view illustrating another example of the display panel in the plasma display apparatus according to the embodiment of the invention.

FIG. 8 is a sectional view illustrating still another example of the display panel in the plasma display apparatus in the embodiment.

FIG. 9 is a sectional view illustrating yet still another example of the display panel in the plasma display apparatus in the embodiment.

FIG. 10 is a sectional view useful to explain an example of structure of an IGBT used for the drive circuit of the plasma display apparatus in the embodiment of the invention.

FIG. 11 is a sectional view useful to explain another example of structure of the IGBT used for the drive circuit of the plasma display apparatus in the embodiment of the invention.

FIG. 12 is a perspective view illustrating an example of structure of a display panel in the plasma display apparatus used generally.

FIG. 13 is a sectional view taken on XIII-XIII line in the FIG. 12 example of structure of the display panel in the general plasma display apparatus.

FIG. 14 is an electrically conceptual diagram equivalent to the display panel in the general plasma display apparatus.

FIG. 15 is a schematic circuit diagram showing an example of a drive circuit of the FIG. 13 general display panel.

FIG. 16 is a schematic circuit diagram showing an example of a drive circuit for driving the display panel in the single-sided drive mode in the general plasma display apparatus.

FIG. 17 is a timing chart showing an example of control signals used for single-sided drive of the display panel in the general plasma display apparatus.

FIG. 18 is a diagram useful to explain how the wall voltage changes during luminescence for Vx>Vy in the double-sided drive mode of the display panel in the general plasma display apparatus.

FIG. 19 is a diagram useful to explain how the wall voltage changes during luminescence for Vy>Vx in the double-sided drive mode of the display panel in the general plasma display apparatus.

FIG. 20 is a diagram useful to explain how the wall voltage changes during luminescence for Vx>Vy in the single-sided drive mode of the display panel in the general plasma display apparatus.

FIG. 21 is a diagram useful to explain how the wall voltage changes during luminescence for Vy>Vx in the single-sided drive mode of the display panel in the general plasma display apparatus.

### DESCRIPTION OF THE EMBODIMENTS

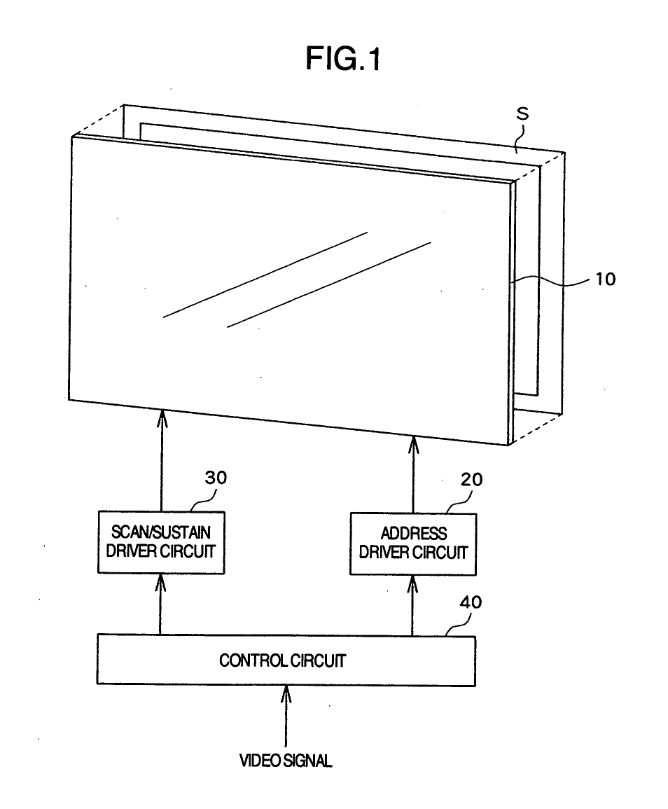

Embodiments of the present invention will now be described with reference to the accompanying drawings. As exemplified in FIG. 1, a plasma display apparatus according to an embodiment of the present invention comprises a display panel 10 supported by a metal chassis S, an address driver circuit 20, a scan/sustain driver circuit 30 and a control circuit 40.

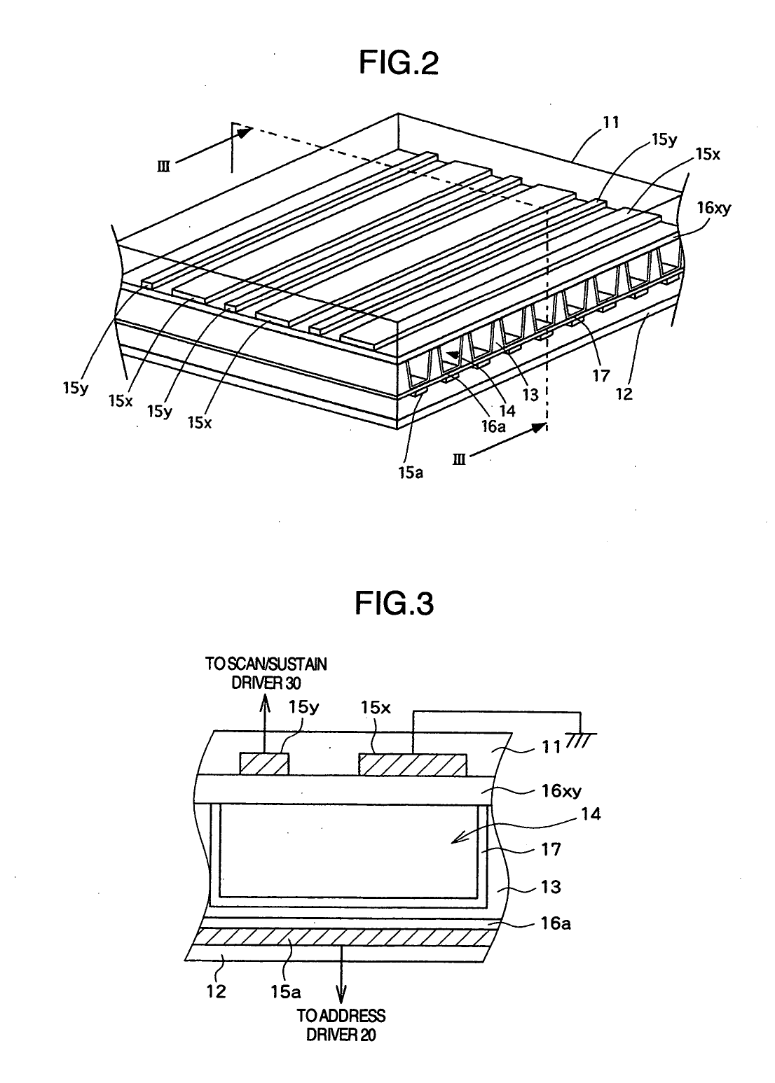

Structurally, the display panel 10 is sandwiched between a front glass 11 and a rear glass 12 as shown in FIG. 2. On the back of the front glass 11, the display panel of plasma display apparatus has a dielectric layer 16xy on which X electrode 15x and Y electrode 15y representing sustaining electrodes are arranged alternately. The X electrode 15x has a width larger than that of the Y electrode 15y and is fixed to a predetermined reference potential. For example, the X electrode 15x is connected to a common terminal (GND). Alternatively, the X electrode 15x may be connected to the metal chassis S.

Namely, when the display panel 10 is sectioned along an address electrode 15a or on line III-III to show a cell in sectional form as shown in FIG. 3, it will be seen that the X electrode 15x is formed to discriminatively have a larger width than that of the Y electrode 15y.

A cavity on the back of the dielectric layer 16xy is partitioned by ribs 13 to form discharge spaces 14. A surface of the rib 13 exposing to the discharge space 14 is laid with a fluorescent layer 17 and a gas such as xenon (Xe) is filled in the discharge space 14.

Address electrodes 15a are formed on the rear glass 12. A dielectric layer 16a intervenes between the address electrode 15a and the discharge space 14.

The X electrode 15x and Y electrode 15y, which are sustaining electrodes, are alternately arranged substantially in parallel and the address electrodes 15a cross the X electrodes 15x and Y electrodes 15y orthogonally thereto, forming a two-dimensional matrix.

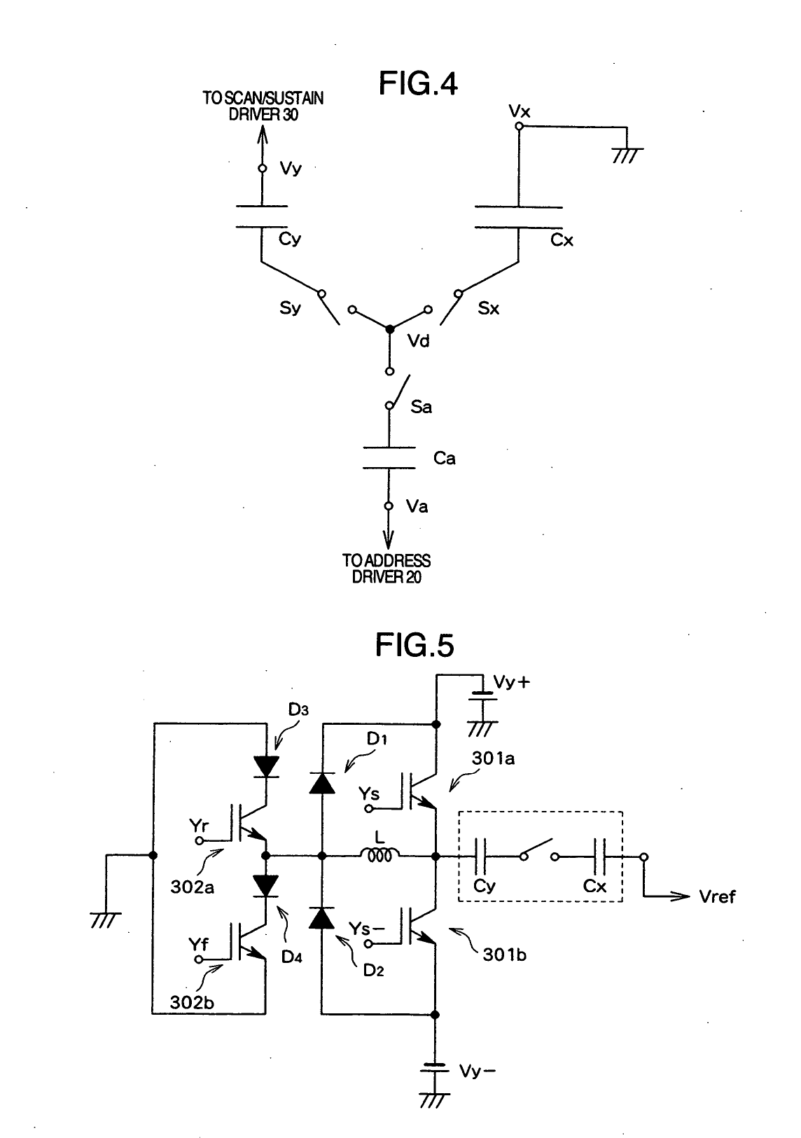

In the display panel 10, the X electrode 15x and Y electrode 15y bound the discharge space 14 through the medium of the dielectric layer 16xy. Therefore, as will be seen from an electrically conceptual diagram of FIG. 4, when the gas filled in the discharge space 14 is activated to plasma (that is, when electrically equivalent switches Sx, Sy and Sa are turned on), the X electrode 15x and Y electrode 15y cooperate with the gas filled in the discharge space 14 to form capacitors Cx and Cy. Since the width of the X electrode 15x is larger than that of the Y electrode 15y, the capacitor Cx connected to the reference potential satisfies Cx>Cy in terms of capacitance.

On the other hand, the address electrode 15a cooperates with the gas filled in the discharge space 14 to form a capacitor Ca through the medium of the dielectric layer 16a.

When voltage is supplied to a Y electrode 15y associated with a cell scheduled to luminesce during the address period, the address driver circuit 20 supplies a predetermined address voltage to the address electrode 15a. During the sustain period, with a view to suppressing a change in the address electrode wall voltage, the address driver circuit 20 may change voltage Va applied to the address electrode 15a to Va=Va+ when Vy=Vs holds and to Va=Va− when Vy=−Vs holds, where Va+>Va−, in synchronism with voltage Vy applied to the Y electrode 15y.

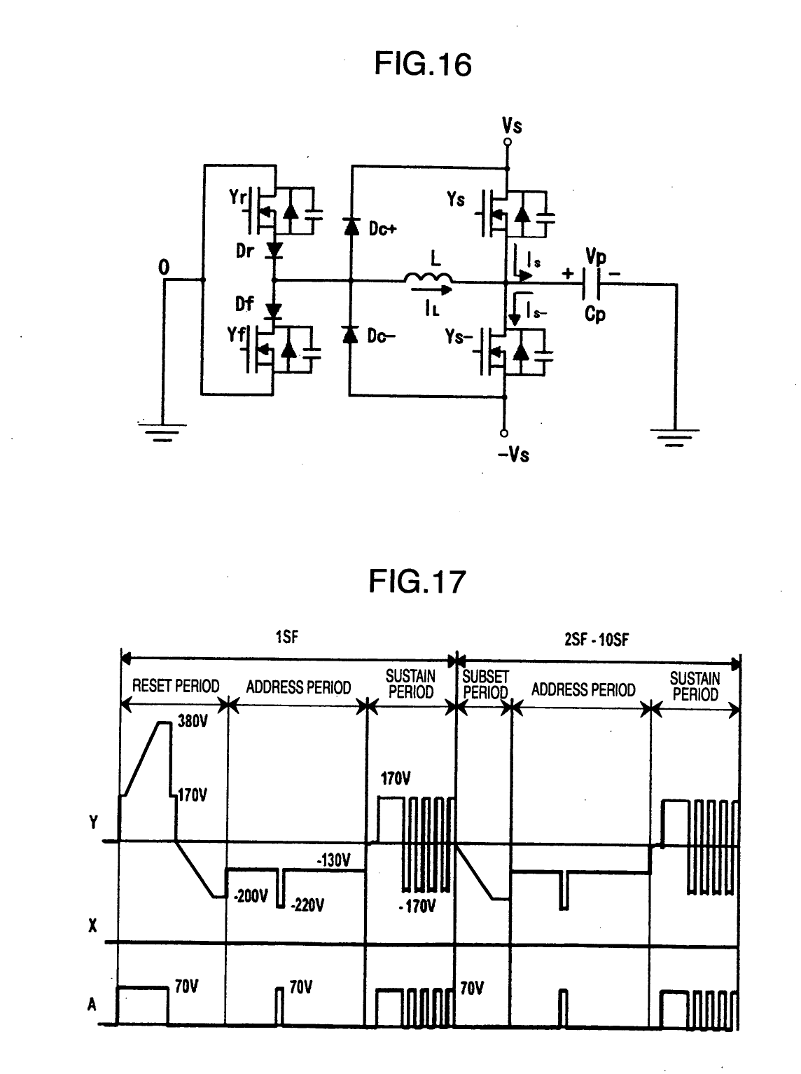

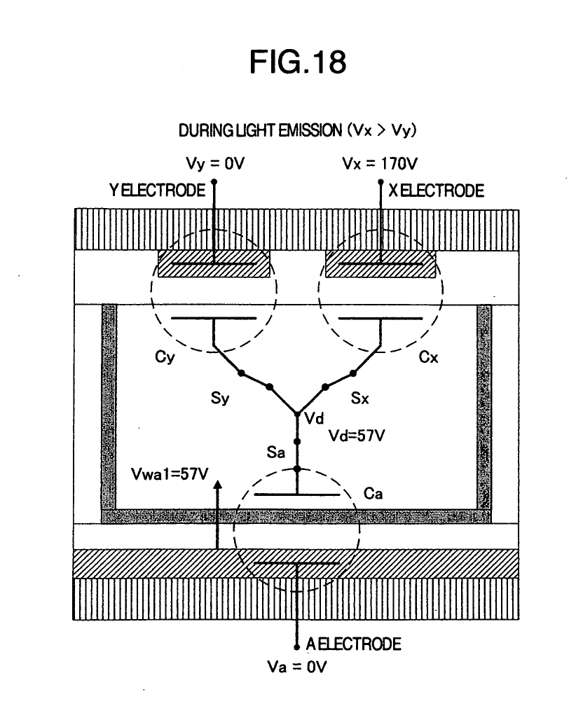

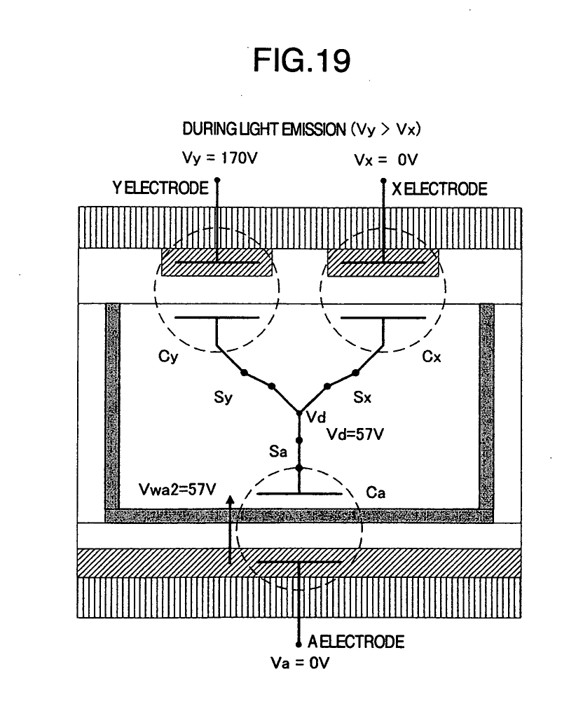

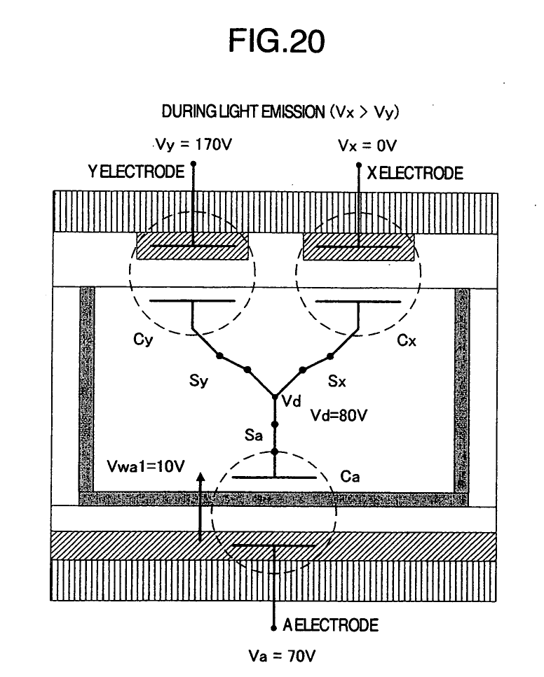

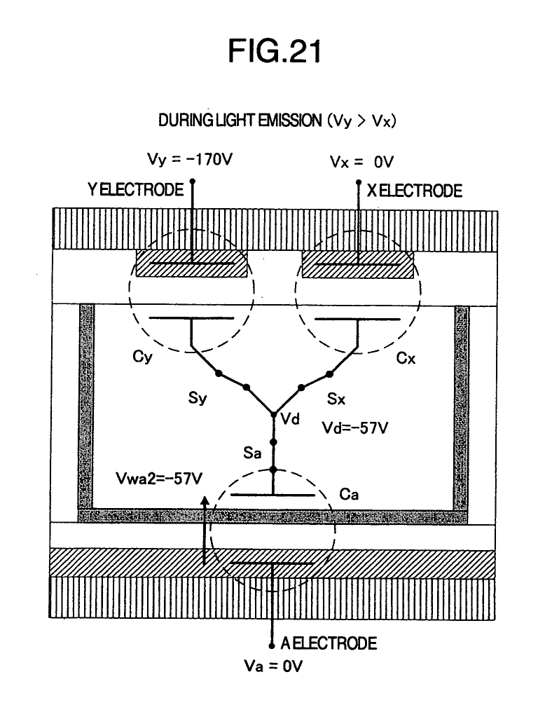

The scan/sustain driver circuit 30 may be materialized with a conventional single-sided drive circuit as exemplified in FIG. 16 but instead a circuit as shown in FIG. 5 can be employed. In the circuit shown in FIG. 5, IGBT's (insulated gate bipolar transistors) substitute for power MOS's used as switch elements in the FIG. 16 drive circuit.

The drive circuit exemplified in FIG. 5 includes a first switch element IGBT 301a for allowing light emission current to flow while clamping its output voltage to a high level, a second switch element IGBT 301b for allowing emission current to flow while clamping the output voltage to a low level and a third switch element comprised of IGBT's 302a and 302b and adapted to charge/discharge the capacitor Cy established between the Y electrode 15y and the discharge space 14 through a coil L.

In the drive circuit exemplified in FIG. 5, a period for turning on the IGBT 301a during the address period is provided in a bid to apply a pulse of predetermined voltage to a Y electrode 15y corresponding to a cell scheduled for light emission. At that time, an address electrode 15a corresponding to the cell ready to luminesce is set to a predetermined potential. As a result, a positive wall charge develops at the Y electrode 15y and negative wall charges develop at the address electrode 15a and X electrode 15x in association with the cell for emission. Then, address discharge proceeds inside the cell caused to luminesce.

Further, in the drive circuit exemplified in FIG. 5, the IGBT 301a and IGBT 301b are turned on alternately during the emission period (sustain period). As a result, a period during which the wall voltage of Y electrode 15y is higher than the wall voltage of X electrode 15x and a period during which the former voltage is lower than the latter voltage develop alternately at the cell in which address discharge has proceeded during the address period. Consequently, sustaining discharge develops between the Y electrode 15y and the X electrode 15x to thereby keep emitting light.

On the basis of an inputted video signal, the control circuit 40 determines luminous brightness of each cell. The control circuit 40 determines sub-fields to make each cell luminesce according to the determined luminous brightness. Then, for the cell scheduled for luminescence, the address driver circuit 20 and the scan/sustain driver circuit 30 are so controlled as to activate address discharge sub-field by sub-field. The control circuit 40 also controls the scan/sustain driver circuit 30 such that sustaining discharge can proceed during the sustain period.

Operation of the display panel in the single-sided drive mode will now be explained with reference to FIG. 4 deemed as an equivalent circuit by describing the internal status of a cell during luminescence when potential Vx at the X electrode 15x and potential Vy at the Y electrode 15y are related to each other by Vx>Vy and Vy>Vx, respectively. In the course of the light emission, the switches Sx, Sy and Sa shown in FIG. 4 are turned on, so that electric charges in the discharge capacitors Cx, Cy and Ca migrate and a balancing state determined by the potential levels Vx, Vy and Va at the individual electrodes is established. In the balancing state, Vd can be calculated as follows:

Vd=(Cx·Vx+Cx·Vy+Ca·Va)/(Cx+Cy+Ca).

It is herein assumed that voltage Va applied to the address electrode 15a is changed to Va=Va+ when Vy=Vs stands and to Va=Va− when Vy=−Vs stands, where Va+>Va−, in synchronism with voltage Vy applied to the Y electrode 15y. Then, with the potential at the X electrode 15x set to 0V (GND potential), address electrode wall voltage Vwa1 when Vy=Vs, Vx=0V and Va=Va+ hold is given by

$$\begin{matrix}Vwal = ( ( Cy \cdot Vs + Ca \cdot Va + ) / ( Cx + Cy + Ca ) ) - Va + \\ = ( Cy \cdot Vs - ( Cx + Cy ) \cdot Va + ) / ( Cx + Cy + Ca )\end{matrix}$$

and address electrode wall voltage Vwa2 when Vy=−Vs, Vx=0V and Va=Va− hold is given by

$$\begin{matrix}Vwa 2 = ( ( - Cy \cdot Vs + Ca \cdot Va - ) / ( Cx + Cy + Ca ) ) - Va - \\ = ( - Cy \cdot Vs - ( Cx + Cy ) \cdot Va - ) / ( Cx + Cy + Ca ) .\end{matrix}$$

In other words, the address wall voltage changes by

Vwa1−Vwa2=(2·Cy·Vs−(Cx+Cy)·(Va+−Va−))/(Cx+Cy+Ca).

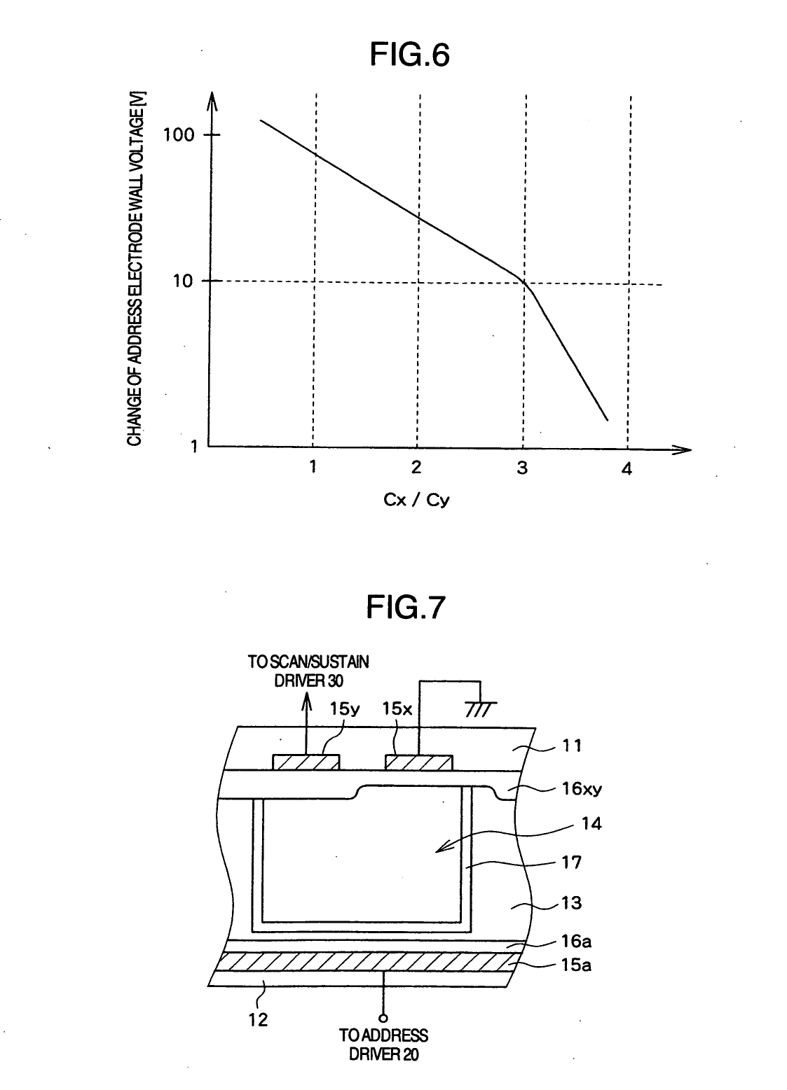

If Vs=170V, Va+=70V and Va−=0V, values of Vwa1−Vwa2 when the ratio between Cx and Cy, (Cx/Cy), is changed can be obtained as graphically illustrated in FIG. 6.

It will be seen from FIG. 6 that as the discharge capacitance of X electrode 15x becomes greater than that of the Y electrode 15y, the address electrode wall voltage less changes and damage on the fluorescent materials can be lessened to suppress the reduction in luminous brightness lifetime. As illustrated in FIG. 6, the address wall voltage changes substantially linearly within a range of Cx/Cy<3 but in a range of Cx/Cy>3, it decreases more steeply and monotonously than in the range of Cx/Cy<3.

By taking advantage of the above results, the control circuit 40 responsive to an input video signal determines luminous brightness of individual cells of the display panel 10 and controls the address driver circuit 20 and scan/sustain driver circuit 30. As a result, an image corresponding to the video signal can be displayed on the display panel 10. At that time, in the plasma display apparatus according to the present embodiment, even when sustaining discharge develops in a cell activated for light emission, the change of address electrode wall voltage can be suppressed as compared to that in the conventional plasma display panel.

In the foregoing description, the example is given where the width of X electrode 15x is made larger than that of Y electrode 15y to make the discharge capacitance Cx of X electrode 15x larger than that Cy of Y electrode 15y but this is not limitative and the discharge capacitance Cx larger than Cy can be attained in other ways.

For example, the thickness of the intervening dielectric layer 16xy may be more decreased at a location where its part intervenes just between the X electrode 15x and the discharge space 14 than at a location where its part intervenes between the Y electrode 15y and the discharge space 14. More specifically, as shown in the FIG. 7 sectional view of the cell, the dielectric layer 16xy differs in its thickness at a portion on which the X electrode 15x is formed and at a portion on which the Y electrode 15y is formed. The discharge capacitance Cx can be larger than Cy also in this way.

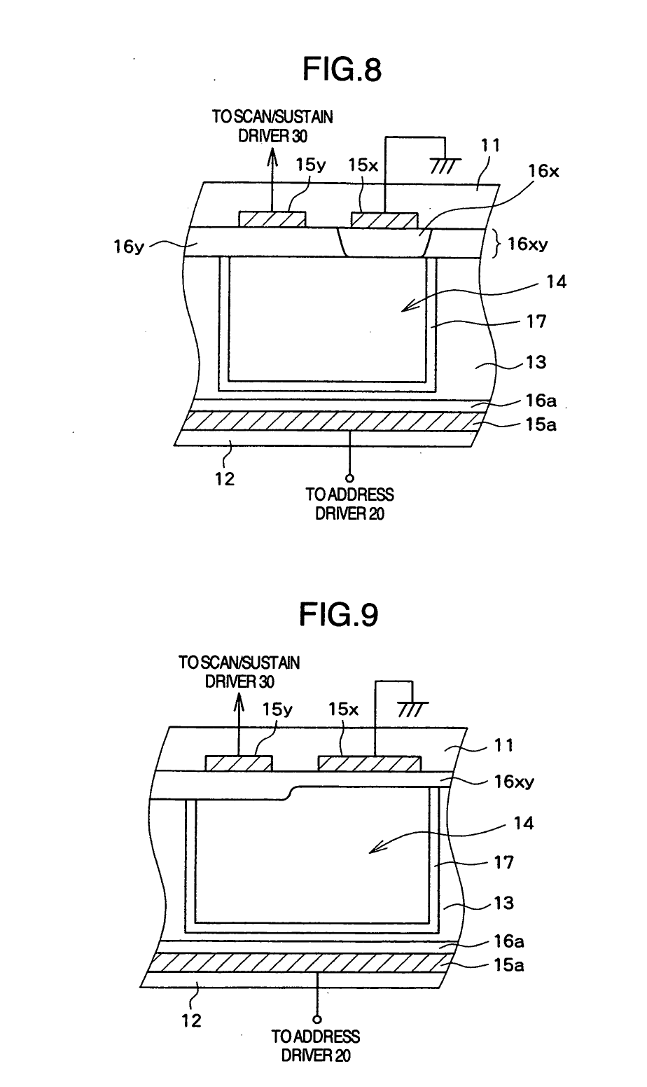

Further, as shown in FIG. 8, the dielectric constant of a portion at which the X electrode 15x is formed may be higher than that of a portion at which the Y electrode 15y is formed. With this structure, the discharge capacitance Cx can also be larger than Cy.

As has been described so far, various methods may be available including (1) making the width of X electrode 15x larger than that of Y electrode 15y, (2) making the thickness of a portion of dielectric layer 16xy intervening between the X electrode 15x and the discharge space 14 thinner than that of a portion of dielectric layer 16xy intervening between the Y electrode 15y and the discharge space 14 and (3) making the dielectric constant of a portion of dielectric layer 16xy at which the X electrode 15x is formed higher than that of a portion of dielectric layer 16xy at which the Y electrode 15y is formed.

One of these methods may be used singularly or two or more of them may be used in combination to anyway realize setting of Cx>Cy. For example, as shown in FIG. 9, while making the width of X electrode 15x larger than that of Y electrode 15y, the thickness of a portion of dielectric layer 16xy intervening between the X electrode 15x and the discharge space 14 may be thinner than that of a portion of dielectric layer 16xy intervening between the Y electrode 15y and the discharge space 14.

The X electrode 15x is now connected to the common potential (GND) but this is not limitative and it may be connected to a power supply or a capacitor maintained at the reference potential.

Next, an example of structure of the IGBT in the drive circuit exemplified in FIG. 5 will be described. The structure of the IGBT can mainly be classified into a planar gate structure and a trench gate structure. Preferably, the control circuit of plasma display apparatus exemplified in FIG. 5 employs an IGBT of trench structure having a larger saturation current density, that is, having insulated gates which are highly dense per unit area so as to be optimized for passing steep current to the capacitive load.

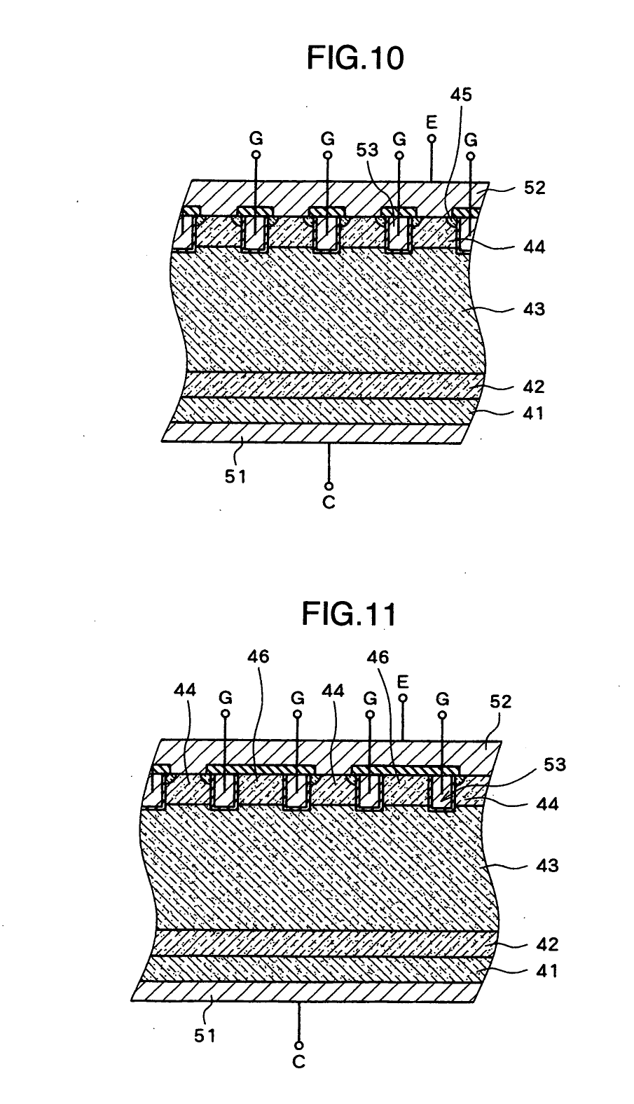

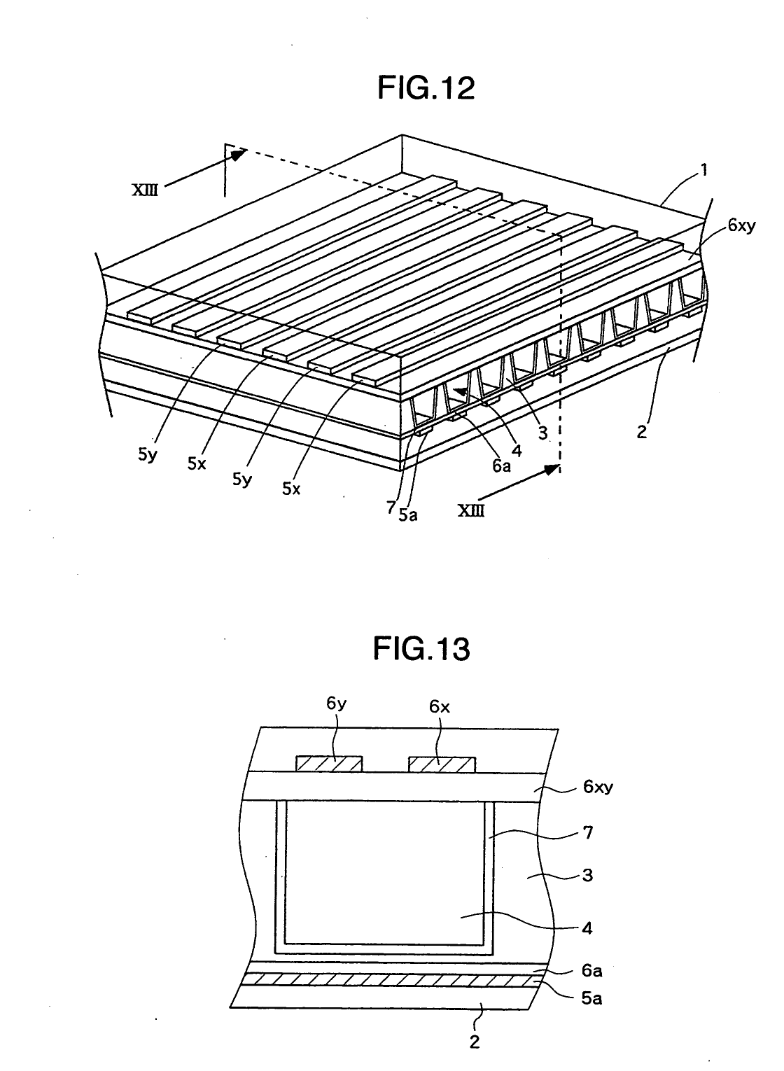

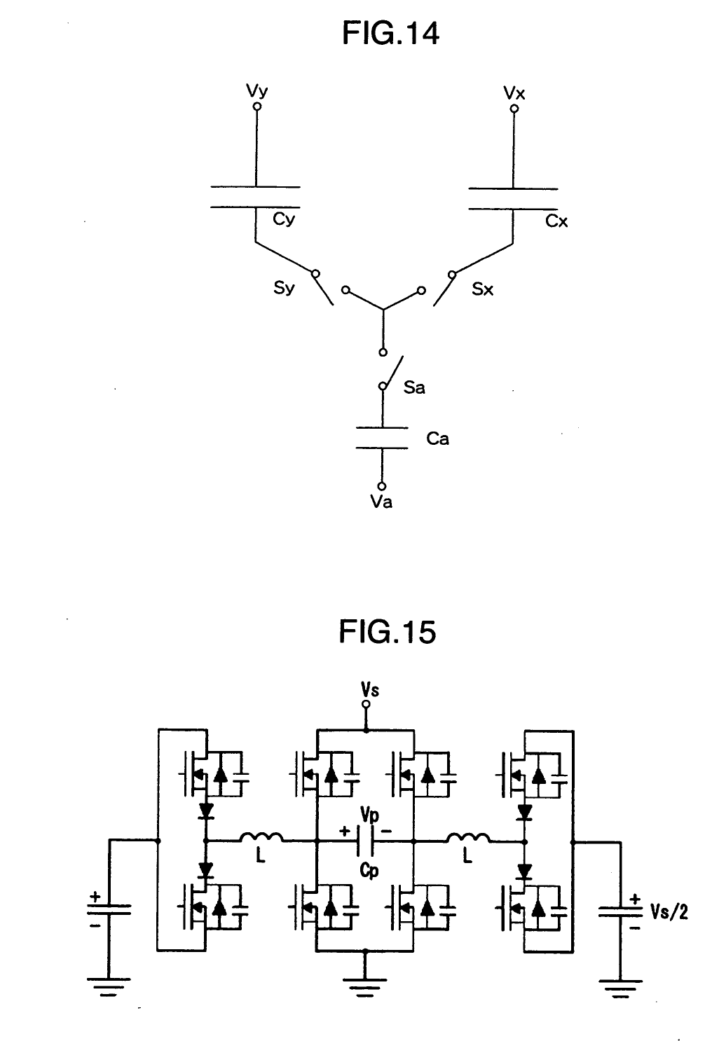

For example, the IGBT includes, as exemplified in FIG. 10, a first semiconductor layer 41 of first conduction type, a second semiconductor layer 42 of second conduction type laminated on the first semiconductor layer 41, a third semiconductor layer 43 of second conduction type laminated on the second semiconductor layer 42 and containing impurities at a lower concentration than the second semiconductor layer, a fourth semiconductor layer 44 of first conduction type laminated on at least part of the third semiconductor layer 43 and containing impurities at a higher concentration than the third semiconductor layer 43, a fifth semiconductor port 45 of second conduction type formed in the fourth semiconductor layer 44 and containing impurities at a higher concentration than the fourth semiconductor layer, a first main electrode 51 in contact with the first semiconductor layer 41, a second main electrode 52 in contact with the fourth semiconductor layer 44 and fifth semiconductor port 45, and an insulated gate port 53 making contact with the fifth semiconductor port 45 and passing through the fourth semiconductor layer 44 to reach the third semiconductor layer 43.

In another structure of the IGBT capable of being used for the drive circuit exemplified in FIG. 5, a region including the fourth and fifth semiconductor layers and a region insulated from the second main electrode 52 (that is, floating) and including a sixth semiconductor layer 46 of first conduction type are alternately interposed among the trench gates of the trench gate type IGBT exemplified in FIG. 10. This structure can promote the conductivity modulation aiming at improving the conductivity in the on-condition and so, can act efficiently even in the plasma display apparatus representing a capacitive load.

The sixth semiconductor layer 46 has been described as being insulated from the second main electrode 52 but the insulation is not always necessary and the sixth semiconductor layer may bound the second main electrode 52 through a resistor.

Further, the IGBT may be controlled for lifetime. In the plasma display panel, high-speed switching at several 10 kHz to several 100 kHz proceeds and therefore, after completion of charge, discharge and passage of emission current, electric charges accumulated inside the switch element need to be extinguished rapidly. This requirement can be met by using the IGBT subject to the lifetime control.

In addition, a switching device including the IGBT's 301a, 301b, 302a and 302b and diodes D1, D2, D3 and D4 as well may be packaged in a single module. In this case, individual elements may be arranged on one surface of a substrate and a heat sink may be connected to the other surface of the substrate. Without resort to the heat sink, the other surface of the substrate may be fixed to the chassis in a bid to achieve heat dissipation.

Further, a gate driver IC for driving the gate of IGBT may be merged into the module. For example, the gate driver IC may also be arranged on the same substrate as used for the IGBT.

It should be further understood by those skilled in the art that the foregoing description has been made on embodiments of the invention and that various changes and modifications may be made in the invention without departing from the spirit of the invention and the scope of the appended claims.

1. A plasma display apparatus having a plurality of display cells, comprising:
a first sustaining electrode;
a second sustaining electrode connected to reference potential and cooperating with said first sustaining electrode to perform sustain discharge through a discharge space of a display cell; and
an address electrode,
wherein an electrical capacitance between said second sustaining electrode and the discharge space is larger than that between said first sustaining electrode and the discharge space.

2. A plasma display apparatus according to claim 1, further comprising a metal chassis for supporting a panel including said first sustaining electrodes, second sustaining electrodes and address electrodes,
wherein said second sustaining electrodes are connected to said metal chassis.

3. A plasma display apparatus according to claim 1,
wherein said second sustaining electrode is connected to a power supply or a capacitor having its output potential maintained at said reference potential.

4. A plasma display apparatus according to claim 1,
wherein said second sustaining electrode has its width larger than a width of said first sustaining electrode.

5. A plasma display apparatus according to claim 1, further comprising a dielectric layer interposing between each of said first and second sustaining electrodes and said discharge space,
wherein said dielectric layer is thinner at its portion intervening between said second sustaining electrode and said discharge space than at its portion intervening between said first sustaining electrode and said discharge space.

6. A plasma display apparatus according to claim 1 further comprising a dielectric layer interposing between each of said first and second sustaining electrodes and said discharge space, wherein said dielectric layer has a higher dielectric constant at its portion interposing just between said second sustaining electrode and said discharge space than at its portion interposing between said first sustaining electrode and said discharge space.

7. A plasma display apparatus according to claim 1, further comprising a drive circuit for applying voltage to said first sustaining electrode,
wherein said drive circuit includes:
a first switch element for passing light emission current while clamping its output voltage to a high level;
a second switch element for passing light emission current while clamping its output voltage to a low level; and
a third switch element for charging and discharging a capacitor formed between said first sustaining electrode and said discharge space through a coil, said first to third switch elements being IGBT's.

8. A plasma display apparatus according to claim 7,
wherein the IGBT's constituting said first, second and third switch elements are controlled for lifetime.

9. A semiconductor device for driving a plasma display apparatus having a first sustaining electrode, a second sustaining electrode connected to reference potential and cooperating with said first sustaining electrode to perform sustaining discharge through a discharge space, and an address electrode, with an electrical capacitance set up between said second sustaining electrode and said discharge space being larger than an electrical capacitance set up between said first sustaining electrode and said discharge space, comprising a drive circuit for applying voltage to said first sustaining electrode, wherein said drive circuit includes:
a first switch element for passing light emission current while clamping its output voltage to a high level;
a second switch element for passing light emission current while clamping its output voltage to a low level; and
a third switch element for charging and discharging the capacitor formed between said first sustaining electrode and said discharge space through a coil, and
wherein each of said first, second and third switch elements is comprised of an IGBT including:
a first semiconductor layer of first conduction type;
a second semiconductor layer of second conduction type laminated on said first semiconductor layer;
a third semiconductor layer of second conduction type laminated on said second semiconductor layer and containing impurities at a lower concentration than said second semiconductor layer;
a fourth semiconductor layer of first conduction type laminated on at least part of said third semiconductor layer and containing impurities at a higher concentration than said third semiconductor layer;
a fifth semiconductor port of second conduction type formed in said fourth semiconductor layer and containing impurities at a higher concentration than said fourth semiconductor layer;
a first main electrode in contact with said first semiconductor layer;
a second main electrode in contact with said fourth semiconductor layer and said fifth semiconductor port; and
an insulated gate port making contact with said fifth semiconductor port and passing through said fourth semiconductor layer to reach said third semiconductor layer.

10. A semiconductor device according to claim 9,
wherein said insulated gate port has a trench gate structure.

11. A semiconductor device according to claim 10,
wherein a sixth semiconductor layer of first conduction type is formed among the insulated gate ports of trench gate structure, the sixth semiconductor layer having an floating potential or being connected to said second main electrode through a resistor.

12. A semiconductor device according to claim 9,
wherein said drive circuit is formed on one surface of a substrate and heat sink means is provided on the other surface of said substrate.

13. A semiconductor device according to claim 9, further comprising, on said substrate, a gate drive device for driving the gates of said first, second and third switch elements.
